(19) United States
(12) Patent Application Publication
(10) Pub. No.: US 2006/0077335 A1
(43) Pub. Date: Apr. 13, 2006

(54) Method of utilizing ink-jetting to form spacer of liquid crystal display panel

(75) Inventors: Kun-Hong Chen, Padeh City (TW); Huai-An Li, Padeh City (TW)

Correspondence Address: BACON & THOMAS, PLLC, 625 SLATERS LANE, FOURTH FLOOR, ALEXANDRIA, VA, 22314, US

(73) Assignee: ChungHwa Picture Tubes., LTD, Padeh City (TW)

(21) Appl. No.: 10/962,483

(22) Filed: Oct. 13, 2004

(51) Int. Cl. G02F 1/1339

(52) U.S. Cl. 349/155

(57) ABSTRACT

The present invention relates to a method of utilizing ink-jetting to form spacers of liquid crystal display panel. As it is after alignment process that spacers are formed by ink-jetting method, interference with alignment process resulting from spacer forming process can be avoided. Further, the present invention can form spacers onto specified positions, and increase obviously the evenness of spacer distribution, consequently the unevenness of cell gap of LCD panel is avoided, and improvement of display quality of LCD panel is achieved.

### BACKGROUND OF THE INVENTION

1. Field of the Invention

The present invention relates to a method of forming spacer of liquid crystal display panel (LCD), particularly to a method of forming spacer of LCD panel by utilizing ink-jetting method, with process sequence being changed.

2. Description of the Related Art

In a conventional method for forming spacer, ball spacers are sprayed onto an upper and a lower substrate after performance of alignment process to keep a certain distance between the substrates (referred to as array and color filter substrate also).

As disclosed in U.S. Pat. No. 6,190,456 patent, the method of spraying spacer thereof requires high standard evenness of spacer distribution and spacers can not easily adhere to alignment layer. This can probably results in scratch and light leakage, and uneven spacer distribution will result in uneven cell gap and low ratio of light transmission; further it has also shortcomings such as poor contrast, lower mechanic strength and color-shift; all those will decrease the quality of display.

In response to the need of large size LCD panels in the market, the requirement to evenness of cell gap between the upper and lower substrate is increasing; therefore, a manufacturing process to form photo spacers onto a color filter substrate has been developed, which can dispose the photo spacers onto the specified positions and promote uniformity of distribution of the photo spacers.

FIG. 1 shows a manufacturing process flowchart of conventional LCD panel, photo spacers are formed onto a color filter substrate (step 10); then after cleaning (step 20), alignment layer coating (step 30) and alignment treating (step 40) are undertaken; thereafter assembling (step 50) and hot press hardening (step 60) are proceeded. However, the above-described manufacturing process has the following shortcomings:
1. light leakage from photo spacer periphery resulting from incomplete alignment rubbing of photo spacer periphery,
2. alignment striations resulting from photo spacer influence on alignment treating,
3. photo spacer material incapability of enduring rubbing action of alignment treating.

Another improved conventional methods, as disclosed in JAPAN patent 2001-108814,A, 2001-109002,A, and 2001-109003,A, utilizing ink-jetting method to form photo spacers; those methods can accurately control ink-jetting positions and can avoid scratch defect resulting from method of spraying spacer; however, it still has the same shortcomings as mentioned because the alignment process is taken after photo spacer forming.

### SUMMARY OF THE INVENTION

The primary objective of the present invention is to provide a manufacturing process of LCD panel and a method of forming photo spacer to improve the problems corresponding to the alignment process, such as incomplete alignment, alignment striations, and light leakage via changing manufacturing process flow sequence. The present invention can avoid scratch of photo spacer and accurately control the position of photo spacers by ink-jetting method.

To achieve the objective mentioned above, the present invention changes the process sequence corresponding to photo spacer forming and alignment process. The alignment process is undertaken before photo spacers are formed onto a color filter substrate or an array substrate by utilizing ink-jetting method, with the substrate being heated via a heating platform thereunder, and with the temperature being closed-loop controlled via a temperature-detecting element in order to cure the photo spacers and avoid the photo spacers being melted resulting from an overheated temperature.

### BRIEF DESCRIPTION OF THE DRAWINGS

FIG. 1 is a flowchart of a conventional manufacturing process of liquid crystal display panel;

FIG. 2A is a flowchart of applying the present invention to a color filter substrate;

FIG. 2B is a flowchart of the present invention applying the ink-jetting method to form photo spacers;

FIG. 3A is the present invention applying ink-jetting method to a color filter substrate to dispense photo spacers;

FIG. 3B is the completion of photo spacer dispensation onto a color filter substrate via the ink-jetting method utilized by the present invention;

FIG. 4 is a flowchart of applying the present invention to an array substrate.

FIG. 5A is the present invention applying ink-jetting method to an array substrate to dispense photo spacers; and

FIG. 5B is the completion of photo spacer dispensation onto an array substrate via the ink-jetting method utilized by the present invention.

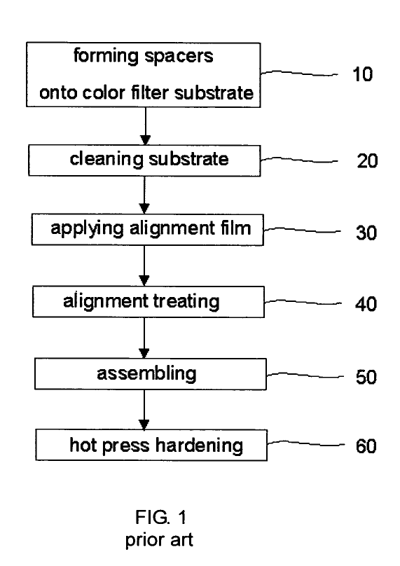

### DETAILED DESCRIPTION OF PREFERRED EMBODIMENTS OF THE INVENTION

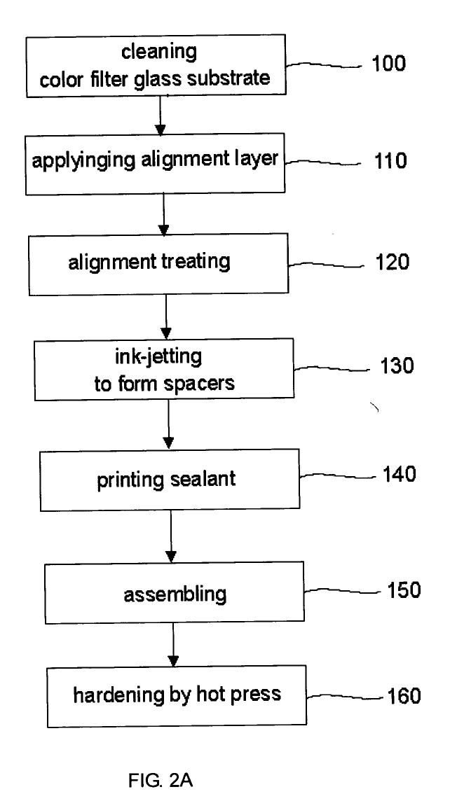

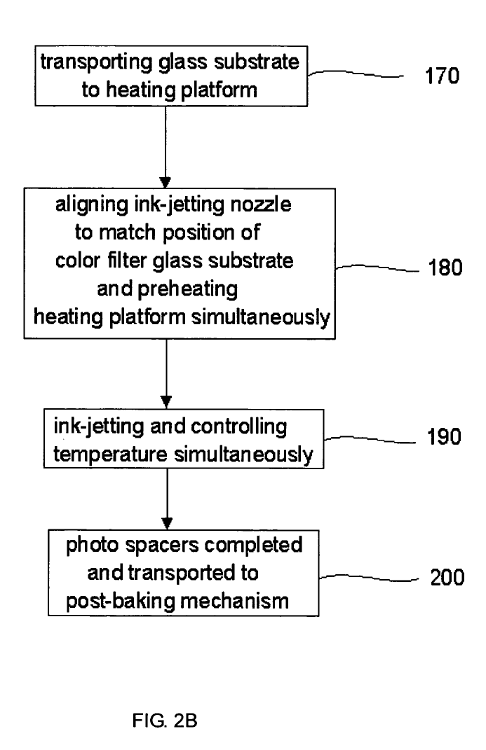

Referring to FIG. 2A, the LCD panel's manufacturing process flowchart of an embodiment of the present invention applying to a color filter substrate 220. Firstly, cleaning the color filter substrate 220 (step 100) is undertaken to remove impurities thereon to ensure cleanliness of ITO(Indium Tin Oxide) of the color filter substrate 220; then after through the conventional manufacturing processes such as photoresist coating, exposing, developing, and etching etc., applying alignment layer (step 110) is undertaken. The alignment layer is an organic thin film formed onto ITO transparent electrode layer placed on inner face of cell. Through a short pre-baking process at 90° C., and through a curing process of a high temperature baking at 200˜300° C. further, and then after the temperature is lowered down to ambient temperature, the color filter substrate 220 is transported to an alignment rubbing machine to undertake alignment process (step 120). The objective of the alignment is to control aligning orientation of liquid crystal molecules and to provide a necessary pretilt angle for different LCD structures. The alignment treating (step 120) involves rubbing the color filter substrate 220, which is placed on a movable platform, with a cloth of nylon or artificial silk attached to a roller, along a specified direction to form a pretilt angle and achieve the effect of alignment treating. After alignment treating, and then through cleaning and printing sealant process, ink-jetting to form photo spacers (step 130) is undertaken to keep the upper and lower substrate in a given distance to make a room to fill liquid crystal thereinto. After completion of above-described major manufacturing processes of photo spacer, the succeeding processes are proceeded, which include printing sealant (step 140), assembling (step 150) and hardening by hot press (step 160) which utilizes the oven's high temperature achieved through a given temperature-rising curve to fix the Is distance thereof.

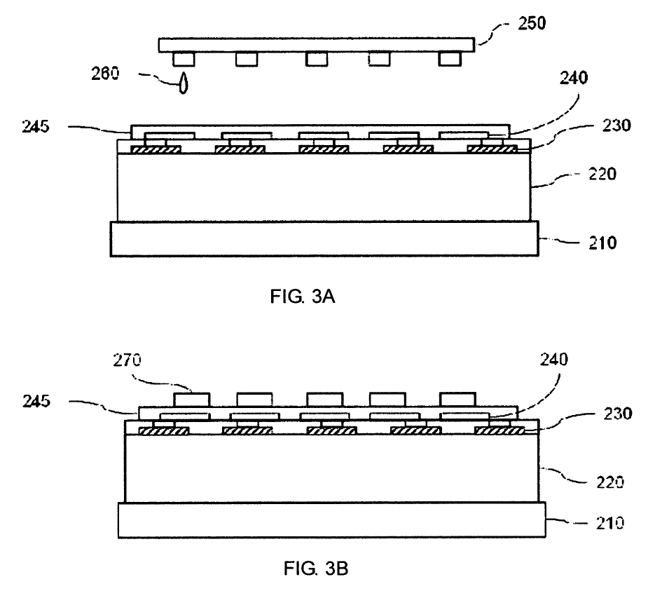

Referring to FIG. 2B and FIG. 3A, the flowchart of applying ink-jetting method to photo spacer forming and the drawing of applying ink-jetting method of forming photo spacers to a color filter substrate. Firstly, the color filter substrate 220 is transported to a heating platform 210 (step 170), with 20 a temperature of the heating platform being set at 70° C.; then proceed an ink-jetting-alignment for the color filter substrate and preheating (step 180), with duration thereof about 60 seconds.

The color filter substrate 220 has a black matrix 230 thereon to avoid an oblique light leakage and raise the contrast of LCD, and after alignment process the color filter substrate 220 has also an alignment layer 245 covering a transparent conductive layer (ITO electrode) 240.

Once the ink-jetting-alignment is finished, an ink-jetting operation is undertaken, and photo spacer's droplets 260 are jetted from an ink-jetting nozzle 250 and dispensed onto the color filter substrate 220, with liquid ink droplets on the color filter substrate 220 being simultaneously heated to cure by the heating platform 210 (step 190).

The heating platform 210 has a temperature-controlling system (not shown) coupled with temperature sensors, such as high reliability thermistor, precision solid state thermistor, and thermal couple. Temperature of the heating platform 210 is monitored and controlled by a temperature-controlling device such as P.I.D to keep the temperature within 90° C.˜110° C. to avoid melting of photo spacers; the process is repeated until photo spacers are dispensed to all predetermined positions.

Referring to FIG. 3B, the completion of photo spacer dispensation onto a color filter substrate via the ink-jetting method utilized by the present invention. Cured photo spacers 270 have adhered to the substrate thereafter, and then the color filter substrate 220 is transported to a post-baking unit to undertake post-baking process (step 200) at 220° C. for about 30 minutes. When completion of post-baking, the succeeding processes are proceeded.

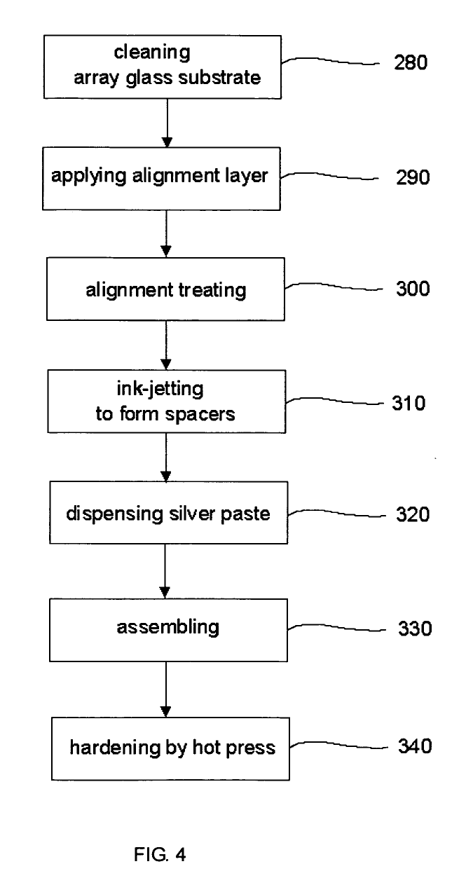

Another embodiment of the present invention is a process to form photo spacers onto an array substrate 350. Referring to FIG. 4, the LCD panel's manufacturing process flowchart of another embodiment the present invention applying to the array substrate 350. Firstly, cleaning the array substrate 350 (step 280) is undertaken to remove impurities thereon to ensure cleanliness of ITO (Indium Tin Oxide) of the array substrate 350; then after the conventional manufacturing processes such as applying photoresist, exposing, developing, etching etc., applying alignment layer (step 290) is undertaken, and then the substrate 350 is transported to an alignment rubbing machine to undertake an alignment treating (step 300). After the alignment rubbing treating, and then through the conventional cleaning and printing sealant, ink-jetting to form photo spacers (step 310) is undertaken. After completion of above-described major manufacturing processes of photo spacer, the succeeding processes are proceeded, which include dispensing silver paste (step 320), assembling (step 330) and hardening by hot press (step 340), which utilizes the oven's high temperature achieved through a given temperature-rising curve to fix the distance thereof.

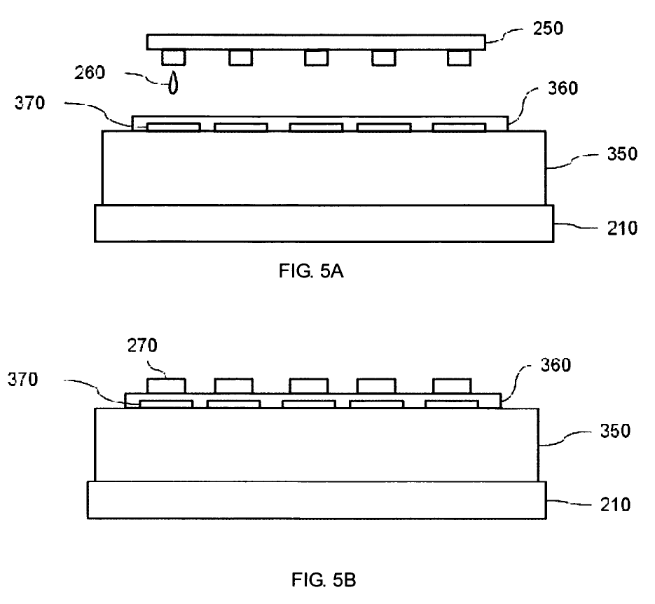

Referring to FIG. 5A, the present invention applying ink-jetting method to an array substrate to dispense photo spacers.

Referring to FIG. 5B, the completion of photo spacer dispensation onto an array substrate via the ink-jetting method utilized by the present invention. The detailed process of photo spacer forming of the current embodiment is same as the preceding embodiment described above, and therefore it would not be described repeatedly.

The descriptions above are just preferred embodiments of the present invention, and it is not to limit scope of the present invention. It is to be understood by persons of the art that various embodiments and modifications may be easily made without departing from spirit of the present invention, which is defined by the appended claims, and that any modification and variation equivalent to the present invention or within scope of the present is to be included within field of appended claims of the present invention.

What is claimed is:

1. A method of forming spacers of liquid crystal display panel, comprising of the following steps:
cleaning a substrate;
applying an alignment layer onto said substrate;
proceeding an alignment treating of said substrate; and
ink-jetting of spacers onto said substrate.

2. A method of forming photo spacers of liquid crystal display panel according to claim 1, wherein said spacers are photo spacers.

3. A method of forming spacers of liquid crystal display panel according to claim 1, wherein said substrate is a color filter substrate.

4. A method of forming spacers of liquid crystal display panel according to claim 1, wherein said substrate is an array substrate.

5. A method of forming spacers of liquid crystal display panel according to claim 1, wherein the primary chemical composition of said alignment layer onto said substrate is polyimide.

6. A method of forming spacers of liquid crystal display panel according to claim 1, wherein steps of applying photoresist, exposing, developing and etching are further included between said cleaning a substrate and said applying an alignment layer onto said substrate.

7. A method of forming spacers of liquid crystal display panel according to claim 1, wherein said alignment treating of said substrate is performed by orientated rubbing.

8. A method of forming spacers of liquid crystal display panel according to claim 1, wherein said ink-jetting further comprising of the following steps:
transporting said substrate to heating platform;
aligning ink-jetting nozzle to match the position of said substrate, and preheating said heating platform simultaneously;
ink-jetting, and controlling temperature of said heating platform simultaneously; and
post-baking said substrate after ink-jetting in post-baking mechanism.
